(19) United States
(12) Patent Application Publication
(10) Pub. No.: US 2018/0077572 A1
(43) Pub. Date: Mar. 15, 2018

(54) DYNAMIC BEACON STREAMING NETWORK AND ASSOCIATED SYSTEMS AND METHODS

(71) Applicant: Smartbeat Pty, Ltd., Perth (AU)

(72) Inventor: Paul Trappitt, Applecross (AU)

(73) Assignee: Smartbeat Pty, Ltd., Perth (AU)

(21) Appl. No.: 15/565,613

(22) PCT Filed: Apr. 11, 2016
(86) PCT No.: PCT/IB2016/052054

§ 371 Date: Oct. 10, 2017

Related U.S. Application Data
(60) Provisional application No. 62/145,875, filed on Apr. 10, 2015.

(51) Int. Cl. H04W 12/06; H04W 12/12; H04L 29/06; H04L 29/08; H04W 8/00; H04W 48/08

(52) U.S. Cl. CPC H04W 12/06; H04W 12/12; H04L 63/0876; H04W 84/12; H04W 8/005; H04W 48/08; H04L 67/20

(57) ABSTRACT

A computer-implemented method of mobile campaign provisioning using a dynamic beacon streaming network system [100] that employs a server [300] and an access point [400c] within a wireless local area network (WLAN) [105]. The server [300] may receive from the access point [400c] identifying information associated with the access point [400c] and/or some number of client devices [400a, 400b] positioned within wireless communication range of the access point [400c]. Identifying information, such as media access control (MAC) addresses [150] of client devices [400a, 400b] are matched by the server [300] to records in a service set identifier (SSID) campaign [170] that comprises SSID(s) configured to provision a mobile campaign message and/or to provide communication access to the WLAN [105]. The access point [400c] executes a display rule associated with each SSID to control display of appropriate SSIDs by the client devices [400a, 400b] as user-selectable network names.

### RELATED APPLICATIONS

This application claims the benefit under 35 U.S.C. § 119(a)-(d) of International Application No. PCT/IB2016/052054 filed on Apr. 11, 2016, and titled Dynamic Beacon Streaming Network Systems and Methods, which claims the benefit under 35 U.S.C. § 119(e) of U.S. Provisional Patent Application Ser. No. 62/145,875 filed by the inventor of the present application on Apr. 10, 2015, and titled Dynamic Beacon Streaming Network Systems and Methods, the entire content of which is incorporated herein by reference except to the extent that disclosure therein is inconsistent with disclosure herein.

### FIELD OF THE INVENTION

The present invention relates generally to wireless local area networks and, more particularly, to dynamically streamed beacons in wireless local area networks, and related systems and methods.

### BACKGROUND

A wireless local area network (WLAN) is a computer network that links two or more stations using a wireless distribution method (often spread-spectrum or orthogonal frequency-division multiplexing (OFDM) radio) within a limited area. All components that can connect into a wireless medium in a network are referred to as stations. All stations are equipped with wireless network interface controllers (WNICs). Wireless stations typically fall into one of two categories: wireless access points, and clients. Access points (APs), such as wireless routers, act as base stations for the wireless network. APs transmit and receive radio frequencies with which wireless enabled devices may communicate. Wireless clients can be mobile devices, such as laptops, personal digital assistants, Voice over Internet Protocol (VoIP) phones and other smartphones, or fixed devices such as desktops and workstations that are equipped with wireless network interfaces.

IEEE 802.11 is a set of media access control (MAC) and physical layer (PHY) specifications for implementing station communication over a WLAN. In these networks, a service set is a set consisting of all the stations associated with a consumer or enterprise IEEE 802.11 WLAN. The basic service set (BSS) provides the basic building block of an IEEE 802.11 WLAN. In infrastructure mode, a single access point together with all associated stations is called a BSS. The access point acts as a master to control the stations within that BSS; the simplest BSS consists of one AP and one station. Each BSS is identified by a service set identifier (SSID), which may comprise a series of 0 to 32 octets. An SSID is used as a unique identifier for a wireless LAN. Because this identifier must often be entered into devices manually by a human user, a typical SSID is often expressed as a human-readable string and, thus, commonly called the “network name.” In normal operation of a wireless AP, the AP will broadcast an IEEE 802.11 beacon frame out of its wireless interface containing information about the network and also connection formalities (e.g. BSSID, AP MAC address, security capabilities). A wireless device in range of the AP will receive the frames and display the network name to the user among a list of available networks on the client device.

To date, the SSID has primarily served as a human-readable string useful only for identifying a WLAN to which a wireless-capable device may connect. Improvements in user experience with WLANs relating to the SSID have been largely overlooked. For example, certain WLAN solutions attempt to add SSID-interpreting intelligence to the processing burden of WIFI-capable client devices, such as the following.

U.S. Pat. No. 8,744,426 to Zhang discloses a method for automatically switching a profile (e.g., ring tone, vibration, volume) of a mobile phone based on a known, pre-set location of the device. Software hosted by the mobile phone may compare an acquired SSID of a WLAN with a pre-stored SSID and, upon detecting a match, may activate a location-specific profile on the device. However, the Zhang implementation merely makes use of, and does not change for further exploitation, the acquired SSID itself.

Consequently, a need exists for systems and methods for advantageously improving the functioning of wireless local area networks. There also exists a need for systems and methods for advantageously enhancing the WLAN experience by providing dynamic SSIDs which may be used for interaction with a user beyond simply being used to select a WLAN. Finally, there exists a need for systems and methods for advantageously providing a mechanism to automatically display a wireless network name to a wireless device whereby an SSID displayed as the network's name may be dynamically selected based on identifying information from the wireless device.

While certain aspects of conventional technologies have been discussed to facilitate disclosure of the invention, the applicant in no way disclaims these technical aspects, and it is contemplated that the claimed invention may encompass one or more of the conventional technical aspects discussed herein. The present invention may address one or more of the problems and deficiencies of the current availability and prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein, or limited to the particular embodiment for the invention used to illustrate the steps and functionality of the herein.

This background information is provided to reveal information believed by the applicant to be of possible relevance to the present invention. No admission is necessarily intended, nor should be construed, that any of the preceding information constitutes prior art against the present invention. This reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### SUMMARY OF THE INVENTION

With the foregoing in mind, embodiments of the present invention are related to systems and methods for dynamically streaming beacons in wireless local area networks. In some embodiments, the system may comprise a client device and an access point both capable of wireless communication. The access point may also be in communication with a server which may have access to a database on a data store. The access point may receive identifying information from the client device and send or transmit this information to the server which may retrieve information associated with the client device identifying information from the database and then send the retrieved information to the access point. The retrieved information may comprise one or more SSIDs with rules on how to cast the SSIDs to the client device. The SSIDs may correspond to real wireless networks allowing the client device to connect to a captive web portal, or the SSIDs may correspond to a fake network that when a connection attempt is made, the access point may cease casting that SSID and begin casting another SSID from the retrieved information.

According to another embodiment consistent with the principles of the invention, a method of dynamically streaming one or more network beacons or probe responses is provided. The method may include the step of capturing a unique identifier, such as a MAC address, from the probe frame of a client wireless device requests by monitoring the wireless traffic in range of a wireless access point. Next, the unique identifier may be sent to a management server running a software program of the system to determine which SSID(s) to stream to the wireless client device to be displayed as available wireless network names by the client device. The SSIDs may be selected based on stored data which may include previously collected data about the client device stored as an SSID campaign in a database accessible to the server. The server may then return the SSIDs to the access point along with rules, triggers, and other information which may be used to govern how the access point is to cast the SSIDs to the client device. The access point may then create a stream of one or more SSIDs to be cast as either beacon frames or probe response frames to the client device according the rules, triggers, and other information of the returned SSID campaign. Finally, the method may include the step of casting a beacon frame or probe response frame with first cast SSID and then replacing it with a beacon frame or probe response frame with a second SSID to be streamed to the client device when the client device attempts to connect the wireless network. Based on the rules and triggers of the SSID campaign, upon interaction with one or more wireless networks, a second beacon frame or probe response frame may be cast which when connected to may connect the client device to a captive portal.

### BRIEF DESCRIPTION OF THE DRAWINGS

FIG. 1 is a schematic diagram of a dynamic beacon streaming network system according to an embodiment of the present invention.

FIG. 2 is a block diagram of a server as used in connection with a dynamic beacon streaming network system according to an embodiment of the present invention.

FIG. 3 is a block diagram of an access point as used in connection with a dynamic beacon streaming network system according to an embodiment of the present invention.

FIG. 4 is a schematic diagram of a beacon frame as used in connection with a dynamic beacon streaming network system according to an embodiment of the present invention.

FIG. 5 is a schematic diagram of a service set identifier (SSID) campaign lookup database as used in connection with a dynamic beacon streaming network system according to an embodiment of the present invention.

FIG. 6A is a flow chart illustrating a method of servicing a specific SSID request using a dynamic beacon streaming network system according to an embodiment of the present invention.

FIG. 6B is a flow chart illustrating a method of servicing a non-specific SSID request using a dynamic beacon streaming network system according to an embodiment of the present invention.

FIG. 7 a block diagram representation of a machine in the example form of a computer system according to an embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

Throughout this disclosure, the present invention may be referred to as a dynamic beacon streaming system, a beacon streaming system, a beacon system, a streaming system, an SSID campaign system, a campaign system, an SSID creator, an SSID streamer, a computer program product, a computer program, a product, a system, a device, and a method. Furthermore, the present invention may be referred to as relating to generally to providing SSIDs. Those skilled in the art will appreciate that this terminology does not affect the scope of the invention.

Example methods and systems for a dynamic beacon streaming network system are described herein below. In the following description, for purposes of explanation, numerous specific details are set forth to provide a thorough understanding of example embodiments. It will be evident, however, to one of ordinary skill in the art that the present invention may be practiced without these specific details and/or with different combinations of the details than are given here. Thus, specific embodiments are given for the purpose of simplified explanation and not limitation.

As used herein, the term “computer” refers to a machine, apparatus, or device that is capable of accepting and performing logic operations from software code. The term “software”, “software code” or “computer software” refers to any set of instructions operable to cause a computer to perform an operation. Software code may be operated on by a “rules engine” or processor. Thus, the methods and systems of the present invention may be performed by a computer based on instructions received as computer software.

The term “electronic device” as used herein refers to a type of machine comprising circuitry and configured to generally perform functions such as recording audio, images, and videos; displaying or reproducing audio, images, and videos; storing, retrieving, and/or manipulating electronic data; providing electrical communications and network connectivity; and other similar functions. Non-limiting examples of electronic devices include the following: personal computers (PCs), workstations, laptops, tablet PCs including the iPad, cell phones including iOS® phones made by Apple Inc., Android® OS phones, Microsoft® OS phones, Blackberry® phones, digital music players, or other electronic device capable of executing computer software and displaying information to a user, memory cards, other memory storage devices, digital cameras, external battery packs, external charging devices, and the like. Certain types of electronic devices which are portable and easily carried by a person from one location to another may be referred to as a “portable electronic device” or “portable device”. Non-limiting examples of portable devices include cell phones, smartphones, tablet computers, laptop computers, wearable computers (such as watches, Google Glasses®), and the like.

The term “client device,” or sometimes “electronic device” or just “device” or “client,” as used herein, refers to a type of computer generally operated by a person. In some embodiments, a client device may be a wireless station configured to send and receive data through IEEE 802.11 wireless specifications to a server which may be operated locally or in the cloud. Wireless stations may fall into one of two categories: wireless access points and clients. Access points (APs), which may comprise wireless routers, may act as base stations for the wireless network. They may transmit and may receive radio frequencies through which wireless enabled devices may communicate. Non-limiting examples of client devices include personal computers (PCs), workstations, laptops, tablet PCs including the iPad®, cell phones including iOS® phones made by Apple Inc., Android® OS phones, Microsoft® OS phones, Blackberry® phones, and other electronic devices capable of executing computer software and displaying information to a user. Certain types of client devices which are portable and easily carried by a person from one location to another may sometimes be referred to as a “mobile device” or “portable device”. Non-limiting examples of mobile devices include cell phones, smartphones, tablet computers, laptop computers, wearable computers (e.g., watches, Google Glasses®), and the like.

The term “computer readable medium” as used herein refers to any medium that may participate in providing instructions to a processor for execution. A computer readable medium may take many forms, including, but not limited to, non-volatile media, volatile media, and transmission media. Non-volatile media may include, for example, and without limitation, optical, magnetic disks, and magneto-optical disks, such as the hard disk or the removable media drive. Volatile media may include dynamic memory, such as the main memory. Transmission media may include coaxial cables, copper wire and fiber optics, including the wires that comprise the bus. Transmission media may also take the form of acoustic or light waves, such as those generated during radio wave and infrared data communications.

As used herein, the term “data network” or “network” refers to an infrastructure capable of connecting two or more computers, such as client devices, either using wires or wirelessly, so as to advantageously allow them to transmit and receive data. Non-limiting examples of data networks may include the internet and “wireless networks”, the latter of which may include wireless fidelity (WIFI) and cellular networks.

As used herein, the term “database” generally refers to a digital collection of data or information. The present invention may use methods and processes to advantageously store, link, and modify information such as digital images, videos, and user profile information. For purposes of the present disclosure, a database may be stored on a remote server and accessed by a client device through the internet (i.e., the database may be in the cloud) or, alternatively, in certain embodiments the database may be stored on the client device or remote computer itself (i.e., local storage). A “data store” as used herein may comprise a database (for example, and without limitation, information and data from a database may be recorded into a medium on a data store).

In describing the invention, it will be understood that a number of techniques and steps are disclosed. Each of these may have individual benefit and each may also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New portable devices and methods for the storage and retrieval of information are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

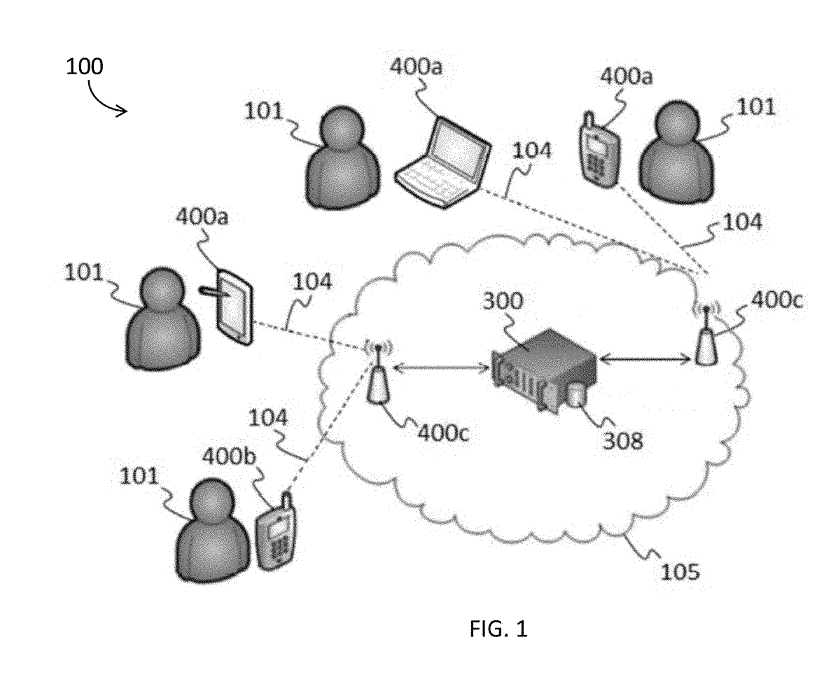

An embodiment of the invention, as shown and described by the various figures and accompanying text, provides a dynamic beacon streaming network system and associated methods. Referring now to FIG. 1, an illustrative example of some of the physical components which may comprise a dynamic beacon streaming network system will now be described in detail. For example, and without limitation, a system 100 may be configured to facilitate the transfer of data and information among one or more stations 400, such as client devices 400a and 400b, access points 400c, and servers 300 over a data network 105. The system 100 also may comprise one or more databases on a data store 308 accessible by the server 300. In one embodiment, the system 100 may comprise at least one client device 400a (but preferably more than one client device 400a, 400b) configured to be operated by one or more users 101. Wireless client devices 400a, 400b, may be mobile devices such as laptops, personal digital assistants, IP phones and other smartphones, or fixed devices such as desktops and workstations that may be equipped with a wireless network interface capable of sending data to one or more servers 300 having access to one or more data stores 308 over a wireless local area network (WLAN) 105.

For purposes of definition, IEEE 802.11 may be defined as a set of media access control (MAC) and physical layer (PHY) specifications for implementing station communication over the WLAN 105. In such networks, and continuing to refer to FIG. 1, a service set may be a set comprising all the stations 400 associated with a consumer or enterprise IEEE 802.11 WLAN 105. The basic service set (BSS) may provide the basic building-block of an IEEE 802.11 WLAN. A station 400 may send and receive data through a network link 104 to one or more wireless access points (AP) 400c. Generally speaking, the AP 400c may act as a master to control the stations within that BSS. Each BSS may be identified by a service set identifier (SSID), which may, for example, and without limitation, comprise a series of 0 to 32 octets. An SSID may be used as a unique identifier for the WLAN 105. Because this identifier must often be entered into devices manually by a human user, an SSID is often created as a human-readable string, thus commonly called the “network name.”

In normal operation, an AP 400c may continually transmit broadcast beacon frames at a specified interval, such as every 100 ms, comprising information about the WLAN 105 provided by the AP 400c. When a user 101 wishes to access wireless networks 105 within communication range of that user's client device 400a, 400b, the user may open the available wireless networks listing on the client device 400a, 440b. The client device 400a may then send a broadcast probe request, thereby becoming a probing client device 400b, which may be received by multiple APs 400c within wireless communication range of the probing client device 400b. The broadcast probe request may comprise information on the client 400b, such as MAC address and signal strength. The AP 400c may then transmit a unicast probe response to the client device 400b with information about the network, such as BSSID, AP MAC address, security capabilities, and the like. The probing client device 400b then may use the probe response information associated with the continual beacon frames the device 400b is receiving to determine if the wireless network is 105 valid and available, and may display the network name (SSID) to the user of the device 400b among a list of available networks which may be displayed on the probing client device 400b.

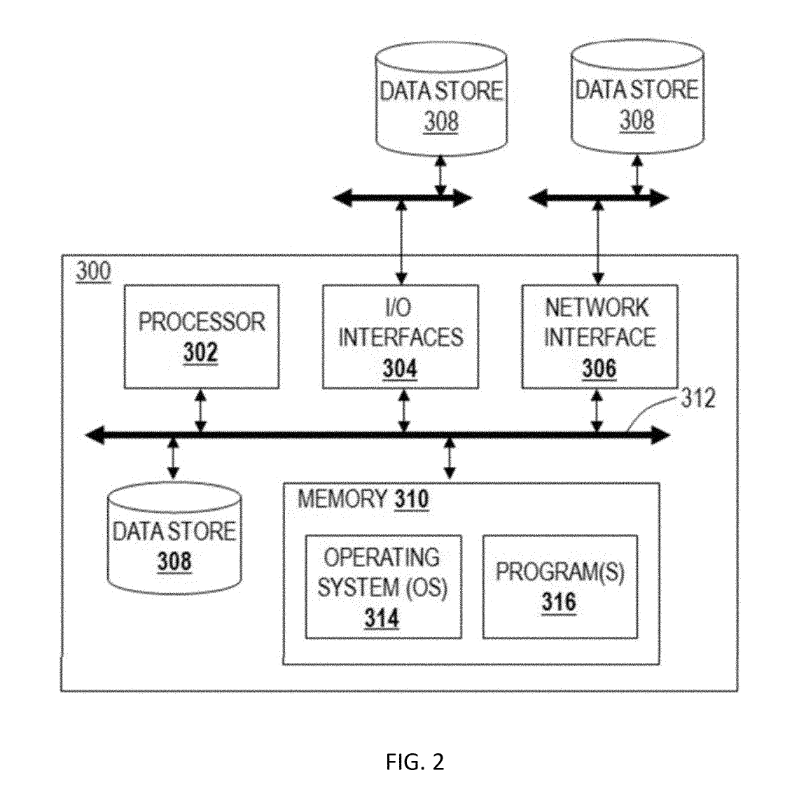

Referring now to FIG. 2, and continuing to refer to FIG. 1, a block diagram illustrating a server 300, of which one or more may be used in the system 100 or standalone, will now be described in detail. For example, and without limitation, the server 300 may be a digital computer that, in terms of hardware architecture, generally may include a processor 302, input/output (I/O) interfaces 304, a network interface 306, a data store 308, and memory 310. It will be appreciated by those of ordinary skill in the art that FIG. 2 depicts the server 300 in an oversimplified manner, and a practical embodiment may include additional components and suitably configured processing logic to support known or conventional operating features that are not described in detail herein.

In one embodiment, the components (302, 304, 306, 308, and 310) may be communicatively coupled via a local interface 312. The local interface 312 may be, for example but not limited to, implemented as one or more buses or other wired or wireless connections, as is known in the art. The local interface 312 may have additional elements, which are omitted for simplicity, such as controllers, buffers (caches), drivers, repeaters, and receivers, among many others, which may be configured to enable communications. Further, the local interface 312 may include address, control, and/or data connections configured to enable appropriate communications among the aforementioned components.

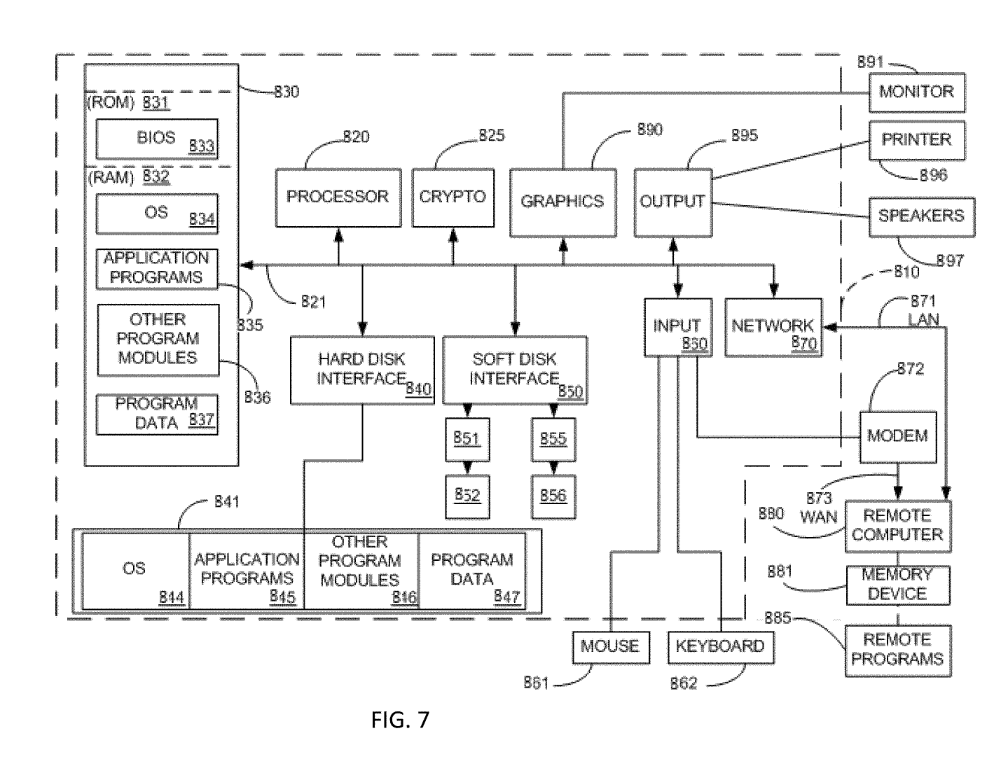

The processor 302 may comprise a hardware device configured to execute software instructions. For example, and without limitation, the processor 302 may be one of a custom made or commercially available processor, a central processing unit (CPU), an auxiliary processor among several processors associated with the server 300, a semiconductor-based microprocessor (in the form of a microchip or chip set), or generally any device for executing software instructions. When the server 300 is in operation, the processor 302 may be configured to execute software stored within the memory 310, to communicate data to and from the memory 310, and to generally control operations of the server 300 pursuant to the software instructions. The I/O interfaces 304 may be used to receive user input from and/or for providing system output to one or more devices or components. User input may be provided via, for example, a keyboard, touch pad, and/or a mouse. System output may be provided via a display device and a printer (not shown in FIG. 2; refer additionally to FIG. 7). I/O interfaces 304 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 306 may be used to enable the server 300 to communicate on a network, such as the Internet, the data network 105, the enterprise, and the like. The network interface 306 may include, for example, and without limitation, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 306 may include address, control, and/or data connections to enable appropriate communications on the network.

A data store 308 may be used to store data. The data store 308 may include any of volatile memory elements (e.g., random access memory (RAM), such as DRAM, SRAM, SDRAM, and the like), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 308 may be located internal to the server 300 such as, for example, and without limitation, an internal hard drive that may be connected to the local interface 312 in the server 300. Additionally, in another embodiment, the data store 308 may be located external to the server 300 such as, for example, and without limitation, an external hard drive that may be connected to the I/O interfaces 304 (e.g., SCSI or USB connection). In a further embodiment, the data store 308 may be connected to the server 300 through a network, such as, for example, and without limitation, a network attached file server.

The memory 310 may include any of volatile memory elements (e.g., random access memory (RAM, such as DRAM, SRAM, SDRAM)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 may include one or more software programs, each of which may include an ordered listing of executable instructions for implementing logical functions. The software in the memory 310 may include a suitable operating system (O/S) 314 and one or more programs 320. The operating system 314 may control the execution of other computer programs, such as the one or more programs 320, and may provide scheduling, input-output control, file and data management, memory management, and communication control and related services. The operating system 314 may be, for example, and without limitation, Windows NT®, Windows 2000®, Windows XP®, Windows Vista®, Windows 7®, Windows 8®, Windows Server 2003/2008® (all available from Microsoft, Corp. of Redmond, Wash.), Solaris® (available from Sun Microsystems, Inc. of Palo Alto, Calif.), LINUX® (or another UNIX variant) (available from Red Hat of Raleigh, N.C. and various other vendors), Android® and variants thereof (available from Google, Inc. of Mountain View, Calif.), Apple OS X 8 and variants thereof (available from Apple, Inc. of Cupertino, Calif.). The one or more programs 320 may be configured to implement the various processes, algorithms, methods, and techniques described herein.

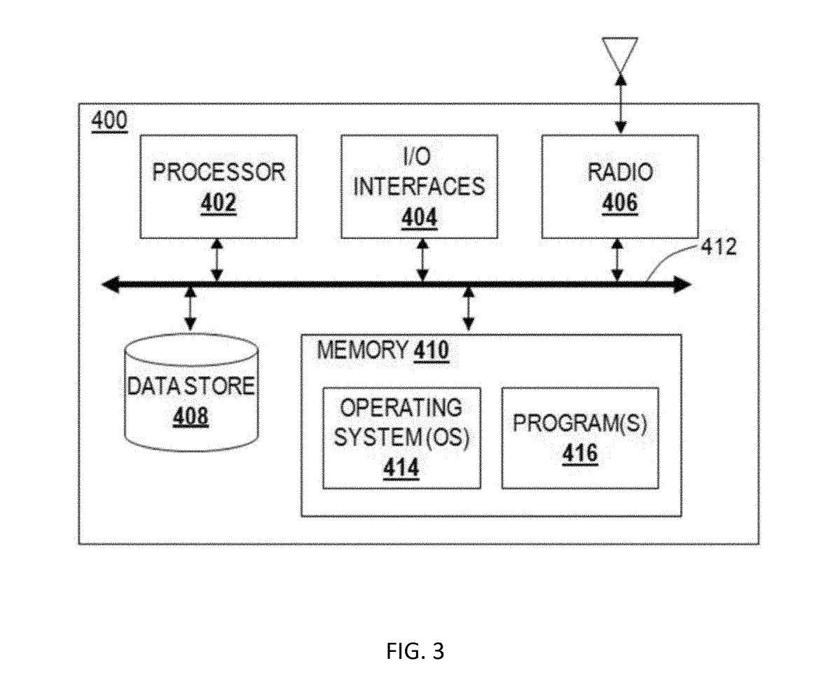

Referring to FIG. 3, and continuing to refer to FIG. 1, a block diagram illustrating a station 400, of which one or more may be used in the system 100, is described in detail. For example, and without limitation, the station 400 may be a digital device that, in terms of hardware architecture, generally may include a processor 402, input/output (I/O) interfaces 404, a radio 406, a data store 408, and memory 410. It will be appreciated by those of ordinary skill in the art that FIG. 3 depicts the station 400 in an oversimplified manner, and a practical embodiment may include additional components and suitably configured processing logic to support known or conventional operating features that are not described in detail herein. The components (402, 404, 406, 408, and 410) maybe communicatively coupled via a local interface 412. The local interface 412 may be, for example, and without limitation, one or more buses and/or other wired or wireless connections, as is known in the art. The local interface 412 may have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 402 may be a hardware device configured to execute software instructions. For example, and without limitation, the processor 402 may be any custom made or commercially available processor, a central processing unit (CPU), an auxiliary processor among several processors associated with the station 400, a semiconductor-based microprocessor (in the form of a microchip or chip set), or generally any device for executing software instructions. When the station 400 is in operation, the processor 402 may be configured to execute software stored within the memory 410, to communicate data to and from the memory 410, and to generally control operations of the station 400 pursuant to the software instructions. In one embodiment, the processor 402 may include a mobile optimized processor such as one optimized for power consumption and mobile applications. The I/O interfaces 404 may be used to receive user input from and/or for providing system output. User input may be provided via, for example, and without limitation, a keypad, a touch screen, a scroll ball, a scroll bar, buttons, bar code scanner, camera, voice recognition, and eye gesture. System output may be provided via a display device such as a liquid crystal display (LCD) and touch screen. The I/O interfaces 404 may also include, for example, and without limitation, a serial port, a parallel port, a small computer system interface (SCSI), an infrared (IR) interface, a radio frequency (RF) interface, and a universal serial bus (USB) interface. The I/O interfaces 404 may include a graphical user interface (GUI) that may enable a user to interact with the station 400.

The radio 406 may function as a wireless network interface and may enable wireless communication to an external access device or network. Any number of suitable wireless data communication protocols, techniques, or methodologies may be supported by the radio 406, for example, and without limitation, RF; IrDA (infrared); Bluetooth®; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; CPRS; proprietary wireless data communication protocols such as variants of Wireless USB; and other generally-available protocols for wireless communication. The data store 408 may be used to store data. The data store 408 may include any of volatile memory elements (e.g., random access memory (RAM, such as DRAM, SRAM, SDRAM, and the like)), nonvolatile memory elements (e.g., ROM, hard drive, tape, CDROM), and combinations thereof. Moreover, the data store 408 may incorporate electronic, magnetic, optical, and/or other types of storage media.

The memory 410 may include any of volatile memory elements (e.g., random access memory (RAM, such as DRAM, SRAM, SDRAM)), nonvolatile memory elements (e.g., ROM, hard drive), and combinations thereof. Moreover, the memory 410 may incorporate electronic, magnetic, optical, and/or other types of storage media. Note that the memory 410 may have a distributed architecture, where various components are situated remotely from one another, but may be accessed by the processor 402. The software in memory 410 may include one or more software programs, each of which may include an ordered listing of executable instructions for implementing logical functions. As illustrated in the example embodiment of FIG. 3, the software in the memory system 410 may include a suitable operating system (O/S) 414 and programs 420. The operating system 414 essentially may control the execution of other computer programs, and may provide scheduling, input-output control, file and data management, memory management, and communication control and related services. The operating system 414 may be, for example, and without limitation, LINUX® (or another UNIX variant), Android® (available from Google), Symbian OS®, Microsoft Windows CEO, Microsoft Windows 7 Mobile®, iOS® (available from Apple, Inc.), webOS® (available from Hewlett Packard), and/or Blackberry OS® (Available from Research in Motion). The programs 420 may include various applications and/or add-ons configured to provide end user functionality with the client device 400. For example, and without limitation, exemplary programs 420 may include, for example, and without limitation, network interface software, a web browser, social networking applications, streaming media applications, games, mapping and location applications, electronic mail applications, and financial applications. In one embodiment, the end user typically may use one or more of the programs 420 to control the functions of a station 400 along with a network such as those components that may be included in the system 100.

Referring again to FIG. 1, in certain embodiments, the system 100 may be configured to automatically display a wireless network name to a wireless client device 400a, 400b, whereby an SSID displayed as the network's name may be dynamically provisioned based on identifying information from the client device 400a, 400b and/or identifying information from the AP 400c. In further embodiments, the system 100 may be configured to display one or more network names and also dynamically change one or more of the displayed network names based on based on analysis of data that may be detected within a probe request frame received from a probing client device 400b. In further embodiments, the system 100 may be configured to display one or more network names and also dynamically change one or more of the displayed network names based on data in identifying information from the AP 400c.

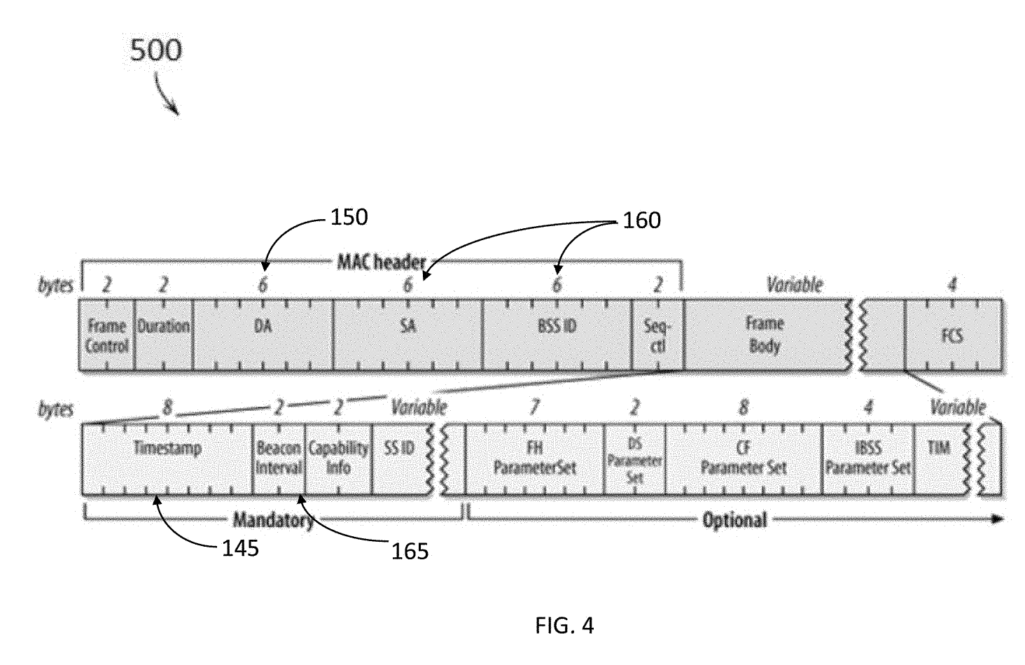

FIG. 4 illustrates a graphical representation of a beacon frame 500 according to various embodiments described herein. For example, and without limitation, an SSID may comprise 32 bytes and may be placed in the SSID field of the beacon frame 500. Continuing to refer additionally to FIG. 1, for a unicast beacon, the MAC Address 150 of the probing client device 400b may be inserted into a DA (Destination Address) field of the beacon frame 500. In a typical broadcast beacon, the DA may contain FF:FF:FF:FF:FF:FF. If the SSID is to represent a real wireless network to which a client device 400b may be able to be connected, the BSSID and SA (Sender Address) fields may be modified to include the actual MAC address (also referred to as AP Identifier 160) of the AP 400c providing the real wireless network (WLAN 105). If the SSID represents a fake network to which a probing client device 400b may not able to be connected, then SA and BSSID fields may be modified to include a fake MAC Address (for example, 00:00:00:00:00:00).

In various embodiments of the invention described herein, MAC addresses may be employed to establish unique identifiers for a probing client device 400b and/or an access point 400c. A person of ordinary skill in the art will recognize that such unique identifiers may be determined from data present in other frames exchanged between the various components of the system 100, and not only from MAC addresses. For example, and without limitation, in certain use situations in which vendors of mobile devices (such as Apple®) are known to randomize the MAC addresses of mobile phones, alternative fields in a probe request, such as tags and sequence numbers, may be used to uniquely identify the probing device. Similarly, although an access point may generally be uniquely identified by its MAC address, a randomly generated and/or stored identifier may be used to uniquely identify the access point.

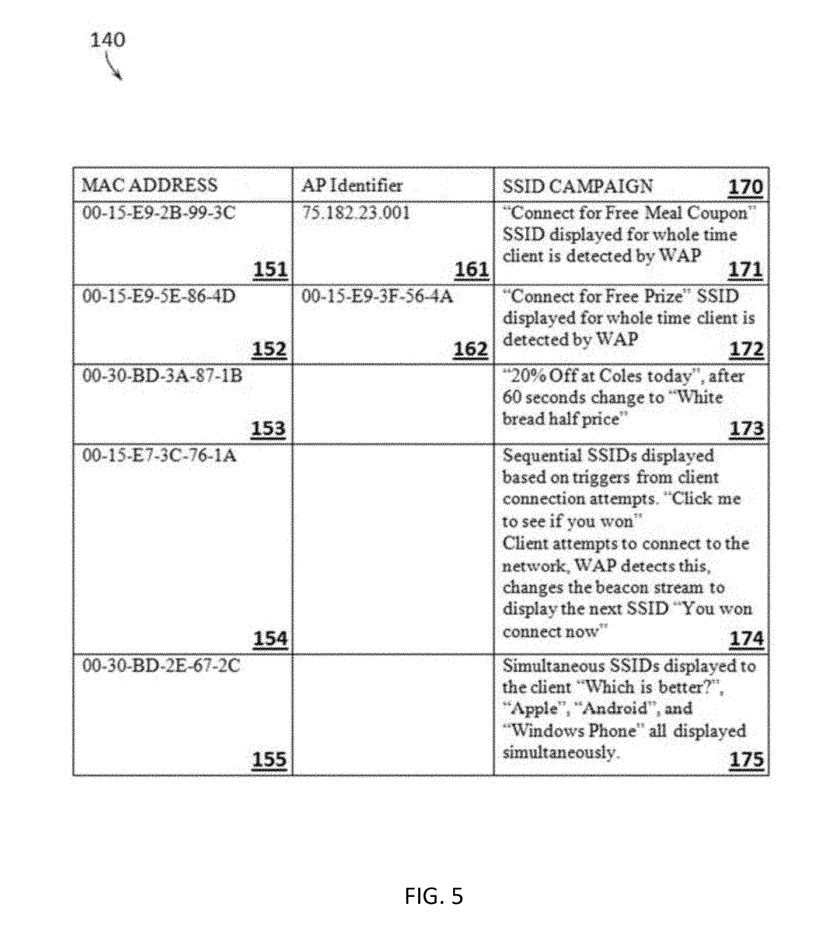

Referring additionally to FIG. 5, in still further embodiments, the system 100 may be configured to display one or more network names and also to dynamically change one or more of the displayed network names based on the MAC address 150 of the probing client device 400b which may be obtained from a probe request type management frame transmitted from the probing client device 400b and received by AP 400c. The AP 400c may then send the MAC address 150 of the probing client device 400b, optionally along with a unique AP identifier 160, such as an IP address of the AP 400c, MAC address of the AP 400c, or any other unique identifier, to the server 300. The server 300 may then retrieve an SSID campaign 170 that may be associated with the probing MAC address 150 and/or the AP unique identifier 160 from a database on a data store 308 accessible to the server 300 and may transmit an associated record from the SSID campaign 170 to the AP 400c. The AP 400c may then transmit one or more unicast beacon frames or probe response frames comprising an SSID from the associated record of the SSID campaign 170 received from the server 300 to the probing client device 400b.

More specifically, FIG. 5 illustrates an example of an SSID campaign lookup database 140 which may be used to advantageously index and/or associate a probing client device 400b with one or more SSIDs of an SSID campaign 170. Referring additionally to FIG. 1, the SSID campaign lookup database 140 may also index and/or associate the unique AP identifier 160 of the AP 400c which received the probing frame from the probing client device 400b with one or more SSIDs of an SSID campaign 170. The probing MAC address 150 of the probing client device 400b and/or the unique identifier 160 of the AP 400c which received the probing frame from the probing client device 400b may be used to select an SSID campaign 170 from an SSID campaign lookup database 140. AN SSID campaign 170 may comprise one or more SSIDs 171, 172, 173, 174, 175 such as a set of SSIDs which may be transmitted by an AP 400c, such as in a beacon frame or probe response frame, to be displayed on a probing client device 400b as one or more network names.

For example, and without limitation, a probing MAC address 150 matching the record 151 value of 00-15-E9-2B-99-3C may be obtained from a probe request type management frame transmitted from a probing client device 400b and received by AP 400c in a specific restaurant. The AP 400c may then send a unique AP identifier 160 matching the record 161 value of 75.182.23.001 of the AP 400c and, optionally, the MAC address 150 of the probing client device 400b to the server 300. The server 300 may then retrieve an SSID campaign record 171 associated with the unique AP identifier 160 matching the record 161 of the restaurant's AP 400c and/or the probing MAC address 150 matching the record 151 from a database 140 on a data store 308 accessible to the server 300, and may transmit the SSID campaign record 171 comprising the SSID “Connect for Free Meal Coupon” to the AP 400c. The AP 400c may then transmit one or more unicast beacon frames or probe response frames to the probing client device 400b comprising the SSID “Connect for Free Meal Coupon” from the SSID campaign record 171 received from the server 300. The probing client device 400b may retrieve the SSID from the unicast beacon frame or probe response frame transmitted by the AP 400c so that when the user 101 views the list of available network names on the user's 101 probing client device 400b, “Connect for Free Meal Coupon” may be displayed in the list of available network names for some portion of the time (in this example, the whole time) that the probing client device 400b is detected by the restaurant's AP 400c.

In another embodiment, for example, and without limitation, the probing MAC address 150 matching the record 152 value of 00-15-E9-5E-86-4D may be obtained from a probe request type management frame transmitted from a probing client device 400b and received by AP 400c. The AP 400c may then send the probing MAC address 150 of the probing client device 400b and, optionally, the unique AP identifier 160 matching the record 162 value of 00-15-E9-3F-56-4A to the server 300. The server 300 may then retrieve an SSID campaign record 172 associated with the probing MAC address 150 matching the 152 value and/or the unique AP identifier 160 matching the 162 value from a database 140 on a data store 308 accessible to the server 300 and transmit the SSID campaign record 172 comprising the SSID “Connect for Free Prize” to the AP 400c. The AP 400c may then transmit one or more unicast beacon frames to the probing client device 400b comprising the SSID “Connect for Free Prize” from the SSID campaign record 172 received from the server 300 to the probing client device 400b. The probing client device 400b may retrieve the SSID from the unicast beacon frame or probe response frame so that when the user 101 views the list of available network names on their probing client device 400b, “Connect for Free Prize” may be displayed in the list of available network names for some portion of the time (in this example, the whole time) that the probing client device 400b is detected by the AP 400c.

In another embodiment, for example, and without limitation, the SSID campaign 170 may also comprise one or more configurable business rules, such as triggers and/or timers, which may govern how the SSIDs of an SSID campaign 170 are to be transmitted by an AP 400c, such as in a beacon frame or probe response frame, to be displayed in the list of available network names on a probing client device 400b. As illustrated in FIG. 5, the probing MAC address 150 matching the record 153 value of 00-30-BD-3A-87-1B may be obtained from a probe request type management frame transmitted from a probing client device 400b and received by AP 400c. The AP 400c may then send the MAC address 150 matching the record 153 value of the probing client device 400b to the server 300. The server 300 may then retrieve an SSID campaign record 173 associated with the probing MAC address 150 matching the record 153 value from a database on a data store 308 accessible to the server 300 and may transmit the SSID campaign record 173 to the AP 400c. In this example, the SSID campaign record 173 may comprise the SSIDs of “20% Off at Coles today” and “White bread half price.” The SSID campaign record 173 also may comprise a timer to change the unicast SSID every 60 seconds (e.g., the “timing event”). The AP 400c may then transmit one or more unicast beacon frames or probe response frames to the probing client device 400b comprising the SSID “20% Off at Coles today” for 60 seconds, and then change the unicast beacon frames or probe response frames to comprise the SSID “White bread half price” from the SSID campaign record 173 received from the server 300 to the probing client device 400b. The probing client device 400b may retrieve the SSID from the unicast beacon frame or probe response frame so that when the user 101 views the list of available network names on the user's 101 probing client device 400b, “20% Off at Coles today” may be displayed for 60 seconds in the list of available network names, followed by “White bread half price” after 60 seconds and for some time period during which the probing client device 400b may be detected by the AP 400c.

In another embodiment, for example, and without limitation, the SSID campaign 170 may also comprise one or more triggers that may be associated with client connection attempts, wherein the trigger(s) may govern how the SSIDs of an SSID campaign 170 may be transmitted by an AP 400c, such as in a beacon frame or probe response frame, to be displayed on a probing client device 400b as one or more network names. For example, and without limitation, the probing MAC address 150 matching the record 154 value of 00-15-E7-3C-76-1A may be obtained from a probe request type management frame transmitted from a probing client device 400b and may be received by AP 400c. The AP 400c may then send the MAC address 150 matching the record 154 value of the probing client device 400b to the server 300. The server 300 may then retrieve an SSID campaign record 174 associated with the probing MAC address 150 matching the record 154 value from a database 140 on a data store 308 accessible to the server 300 and transmit the SSID campaign record 174 to the AP 400c. In this example, the SSID campaign record 174 may comprise the SSIDs of “Click me to see if you won” and “You won connect now.” The SSID campaign record 174 also may comprise a trigger (in the form of a rule like that described above for SSID campaign record 173) to sequentially change the unicast SSID in response to client connection attempts. The AP 400c may then transmit one or more unicast beacon frames or probe response frames to the probing client device 400b comprising the SSID “Click me to see if you won.” If the probing client device 400b transmits a wireless authentication frame to connect to the AP 400c based on a user 101 selecting the network name “Click me to see if you won”, this action may then trigger the AP 400c to change the transmitted unicast beacon frame or probe response frame to comprise the SSID “You won connect now” from the SSID campaign record 174 received from the server 300 to the probing client device 400b. The probing client device 400b may retrieve the second SSID from the unicast beacon frame or probe response frame so that when the user 101 views the list of available network names on the user's 101 probing client device 400b, “You won connect now” may be displayed instead of “Click me to see if you won” in the list of available network names for some portion of the duration that the probing client device 400b may be detected by the AP 400c.

In another embodiment, for example, and without limitation, the SSID campaign 170 may comprise one or more SSIDs which may be transmitted simultaneously by an AP 400c, such as in multiple beacon frames or probe response frames, and which may be simultaneously displayed on a probing client device 400b as multiple network names. For example, and without limitation, the probing MAC address 150 matching the record 155 value of 00-30-BD-2E-67-2C may be obtained from a probe request type management frame transmitted from a probing client device 400b and received by AP 400c. The AP 400c may then send the MAC address 150 matching the record 155 value of the probing client device 400b to the server 300. The server 300 may then retrieve an SSID campaign record 175 associated with the probing MAC address 150 matching the record 155 value from a database 140 on a data store 308 accessible to the server 300 and may transmit the SSID campaign record 175 to the AP 400c. In this example, the SSID campaign record 175 may comprise the SSIDs of “Which is better?”; “Apple”; “Android”; and “Windows Phone”. The SSID campaign record 175 also may comprise a trigger (in the form of a rule like that described for SSID campaign 173 above) that may govern simultaneous display the SSIDs of the SSID campaign record 175. The AP 400c may then transmit different unicast beacon frames or probe response frames to the probing client device 400b, each of which may comprise one of the SSIDs from the SSID campaign record 175. The probing client device 400b may retrieve the SSID from each unicast beacon frame or probe response frame so that when the user 101 views the list of available network names on the user's 101 probing client device 400b, “Which is better?”; “Apple”; “Android”; and “Windows Phone” will be displayed in the list of available network names while the probing client device 400b is detected by the AP 400c.

In another embodiment, for example, and without limitation, the AP 400c may be configured to generate a hotspot using one or more SSIDs of an SSID campaign 170. A hotspot may comprise a genuine wireless network named after an SSID of an SSID campaign 170 that may not be available for connected. Upon connection the user may be optionally allowed to connect to the internet, or optionally restricted from accessing the internet, and may be redirected to a web-based captive portal that may be hosted on a centralized server 300. As part of the redirection, the AP 400c hosting and executing the hotspot may pass connection information about the probing client device 400b, such as the MAC address 150 of the probing client device 400b, to the web server 300 hosting the captive portal. The captive portal may inform the AP 400c if the client device 400b should be allowed access to the internet, at which time the AP 400c may either grant or deny access to the internet.

For example, and without limitation, a captive portal may comprise a web page that may be used as a landing page and login page to access the internet when connecting to a hotspot. Generally, in normal public WIFI scenarios, such a page may process some form of validation of the client device 400b, such as by taking a payment and/or by asking the user to accept terms and conditions and/or by asking the user to leave an email address and/or other form of social identification. The captive portal web page may be used to display information such as dynamic targeted marketing based on awareness of the unique MAC address 150 of the client device 400b, and may determine, from previous records such as those contained in a database like an SSID campaign lookup database 140, a profile of the client device 400b which may drive the content that may be displayed on the captive portal web page at the time of connection.

In another embodiment, for example, and without limitation, an SSID campaign 170 may comprise hotspot and/or captive portal information which may be used to configure the AP 400c to generate a hotspot and/or captive portal using one or more SSIDs of an SSID campaign 170. After a user 101 selects a specific SSID from the SSID campaign 170 of available network names while the probing client device 400b is detected by the AP 400c, the AP 400c may direct the client device 400b to a specific captive portal webpage. In further embodiments of the system 100, a captive portal page may use previously-collected connection event information about an SSID to which a particular user's 101 probing client device 400b may have connected in the past in order to govern content that may be provided to the client device 400b from the SSID campaign 170. This content may be in the form of a coupon or offer that may be redeemed in store, targeted advertising, additional information relating to an SSID of the SSID campaign 170, or any other digital content including text, graphics, audio, video, and other digital content.

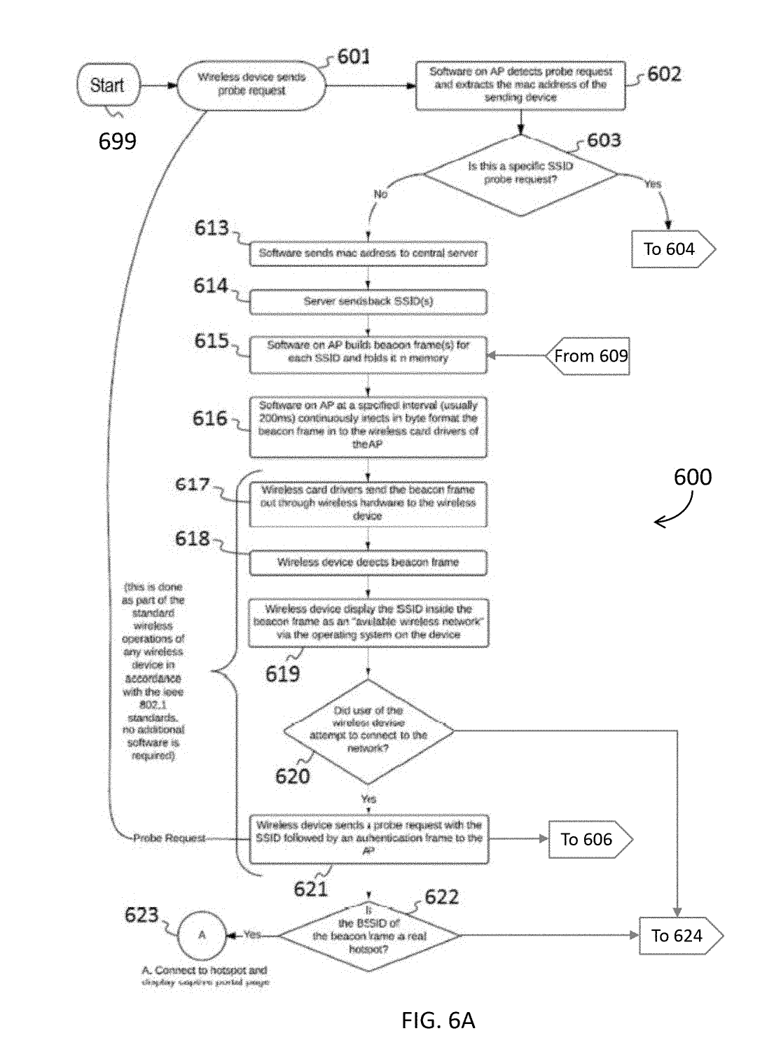

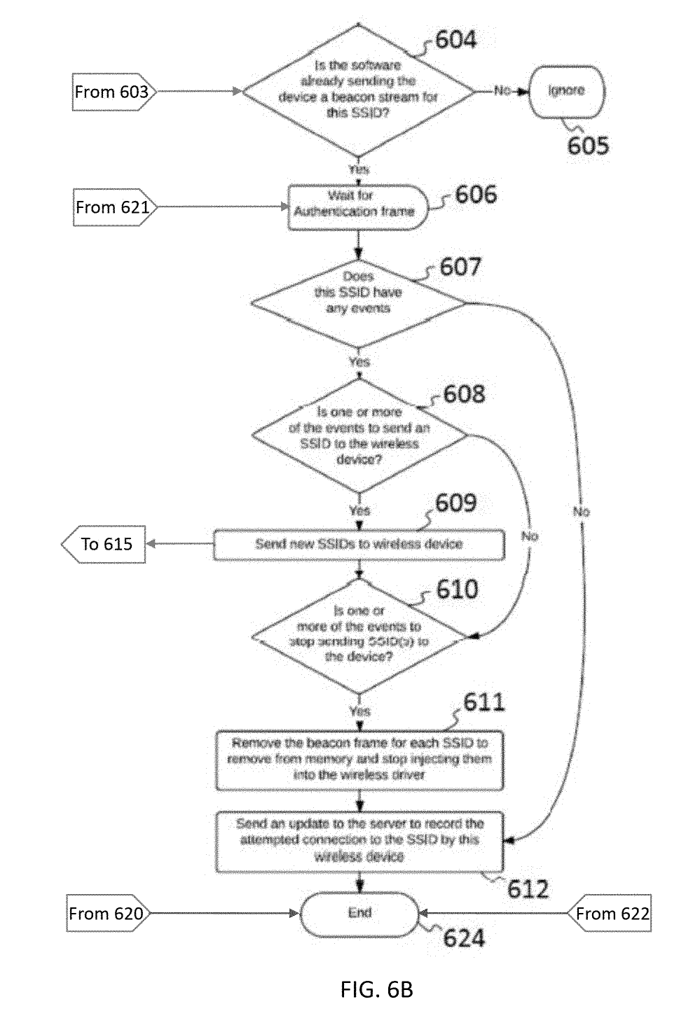

Referring now to FIGS. 6A and 6B, and continuing to refer to FIGS. 1 and 3, an example method for dynamic beacon streaming (“the method”) 600 according to various alternative embodiments of the present invention is now described in detail. For example, and without limitation, steps of the method 600 which may be completed by an access point (AP) 400c, may be configured by installing and running a software program 416 of the system 100 on an AP 400c, such as a commercially available wireless access point. The access point control software program 416 may configure the wireless interface of the AP 400c to enter into a monitoring mode and may also utilize network interface software such as libpcap open source network interface software to listen and capture wireless traffic, such as IEEE 802.11 wireless frames being transmitted by a client device 400b within wireless communication range of the AP 400c. The system software program 416 may analyze the received IEEE 802.11 wireless frames to detect specific probe request type management frames, such as type 0 subtype 4 transmitted by a probing client device 400b.

After a frame is detected, data from the probing client device 400b, such as the MAC address 150, timestamp 145, and signal strength 165, may be extracted from the frame. The software program on the AP 400c may then send extracted data, such as the MAC address of the probing client device 400, along with a unique AP identifier 160 for the monitoring AP 400c to a management server 300 on the internet via the internet connected interface (WAN) of the AP 400c. The management server 300 may then analyze the unique probing client MAC address 150 and/or AP 400c unique identifier 160 against a set of configurable business rules that may be contained in an SSID campaign 170 and previously collected data which may be stored in a database, such as an SSID campaign lookup database 140, on a data store 308 that may be accessible to the server 300. The management server 300 then may transmit one or more SSIDs, such as may be contained in an SSID campaign 170, that may be associated with the probing client MAC address 150 and/or AP 400c unique identifier 160 to the AP 400c. The AP 400c may then transmit one or more unicast beacon frames or probe response frames comprising an SSID 171, 172 received from the server 300 to the probing client device 400.

Referring additionally to FIG. 4, for example, and without limitation, the AP 400c may then use rules such as timers 173 and triggers 174 in the SSID campaign 170 to setup one or more real or fake wireless networks by transmitting one or more beacon frames 500 or probe response frames, such as a stream of beacon frames or probe response frames. Real wireless networks may allow connection to the internet such as to a web portal, while fake wireless networks may not provide a connection to the internet (e.g., may instead be displayed to deliver a mobile campaign/advertising message). In the event that a probing client device 400b attempts to connect to a fake wireless network, the connection attempt may serve as a trigger to stop transmitting the beacon frame with a first SSID and then begin transmitting another beacon frame or probe response frame with another SSID of the SSID campaign 170. The AP 400c may send one or more simultaneous or scheduled streams of unicast IEEE 802.11 beacon management frames or probe response frames to the probing client device 400b based on the rules, triggers, and SSID(s) present in the SSID campaign 170. The probing client device 400b may display these beacon frames or probe response frames on a list of available wireless networks that may be maintained by the probing client device's 400b operating system, thereby presenting each SSID from the SSID campaign 170 as the respective name of an available network. If a user of a probing client device 400b displaying a fake wireless network from the AP 400c selects to connect to that network, an authentication frame may be sent from the probing client device 400b to the AP 400c with the BSSID specified in the previously received beacon frame or probe response frame. When this authentication frame is detected by the system software program 416 monitoring on the AP 400c, the program 416 may send a notification of this action along with a timestamp 145 and the SSID to the management server 300. The management server 300 may log this event in a database, such as in an SSID campaign lookup database 140, for further analysis and reporting.

In another embodiment, for example, and without limitation, if the BSSID is not a real wireless network, the system program 416 may (if directed to do so by the returned SSID campaign 170) change the SSID of the beacon frame currently being streamed to the probing client device 400b to a new SSID specified by the SSID campaign 170. As the BSSID is not real, no association or connection may be completed between the probing client device 400b and the AP 400c. The probing client device 400b may then display a new SSID and the previous one may disappear. If the BSSID is a real wireless network such as a hotspot, the probing client device 400b may associate or connect to the hotspot and may be presented with a captive portal page. This method may be used to deliver dynamic campaign-related content to the user 101, such as a coupon or offer. The captive portal page may be hosted on a centralized server 300 which may record an SSID with which the probing client device 400b has interacted for use in tailoring of the captive portal page for the connection attempt to the specific SSID. Such tailoring may be facilitated through the use of the stored interaction event data from the previous detection and logging of the authentication frame during the connection phase.

Still referring to FIGS. 6A and 6B, but in more detail, for example, and without limitation, the method 600 from the start (Block 699) may comprise a probing client device 400b sending or transmitting a probe request frame (Block 601). A software program 416 on an AP 400c may then detect the probe request and extract the MAC address 150 of the probing client device 400b (Block 602). At Block 603, the program 416 may determine if the probe request of the probing client device 400b is for a specific SSID being transmitted by the AP 400c. If the detected request is a specific SSID request, the software 416 may determine if the software of the AP 400c is already sending the client device a beacon stream or probe response frame stream for the specific SSID (Block 604). If the program 416 is not sending the specific SSID, the method may proceed to Block 605 and the program 416 may ignore that client device. If the program 416 is sending the specific SSID, the method may proceed to Block 606 and the program 416 of the AP 400c may wait for an authentication frame from the probing client device 400c.

Next, the program 416 may determine if the SSID sent in the beacon stream or probe response frame has any events in Block 607, such as received authentication frames from a probing client device 400b. If the SSID does not have any events, the program 416 may continue to Block 612, and the program 416 may send an update to the server 300 to record, in a database such as an SSID campaign lookup database 140, in a data store 308 accessible to the server 300 the lack of events of that SSID by the probing client device 400b.

If the SSID does have events, the program 416 may determine if one or more of the events were an authentication frame with the SSID from the probing client wireless device 400b in Block 608. If one of the events was not to send an SSID to the probing client device 400b, the method may continue to Block 610. If one of the events was to send an SSID to the probing client device 400b, a new SSID from the SSID campaign 170 may be sent to the wireless probing client device 400b in Block 609 and then the method may continue to Block 610.

In Block 610, the program 416 may determine if one or more of the events were to stop sending one or more SSIDs to the probing client device 400b. If one or more of the events were to stop sending one or more SSIDs to the probing client device 400b, the method 600 may proceed to Block 611 and the program 416 may direct the AP 400c to remove the beacon frame or probe response frame for each SSID such as by removing the SSID from the memory 410 of the AP 400c and to stop inserting such SSIDs into the wireless driver of the network interface. Next, the program 416 may send an update to the server to record, such as in an SSID campaign lookup database 140, an attempted connection, such as with an authentication frame, to the SSID by the probing client device 400b in Block 612. Next, the method 600 may end in Block 624.

Referring again to FIG. 6A, at Block 603, if the program 416 determines the probe request of the probing client device 400b is not for a specific SSID being transmitted by the AP 400c, the software program 416 may send the MAC address 150 of the probing client device 400b to the central or managing server 300 in Block 613. The server 300 may then retrieve the SSID campaign 170 associated with the MAC address 150 of the probing client device 400b from a database, such as an SSID campaign lookup database 140. The server 300 may then send the SSID campaign 170 comprising one or more SSIDs to the AP 400c in Block 614. Next, the program 416 of the AP 400c may build one or more beacon frames for each SSID of the SSID campaign 170 and may hold or store the beacon frames or probe response frames in memory 410 in Block 615. In Block 616, the software program 416 may continuously insert, in byte format, one or more of the built beacon frames or probe response frames into the wireless card drivers of the network interface of the AP 400c.

In some embodiments, Blocks 617-621 may be carried out as part of the standard wireless operations of any wireless station or wireless device in accordance with IEEE 802.11 standards with no additional software programs 416 or intervention from a software program 416 of the system 100. In Block 617, the wireless card drivers of the network interface may send the beacon frame comprising an SSID from the SSID campaign 170 out through wireless hardware of the network interface to the probing client device 400b. The wireless probing client device 400b may detect the beacon frame or probe response frame in Block 618. Next, the probing client device 400b may display the SSID inside the beacon frame or probe response frame as an available wireless network via the operating system on the probing client device 400b in Block 619.

In Block 620, the system program 416 may determine if the user of the probing client device 400b attempted to connect to the network associated with the SSID of the beacon frame or probe response frame such as with an authentication frame. If the user did not attempt to connect, the method 600 may proceed to Block 624 and the method 600 may end. If the user did attempt to connect, and the wireless probing client device 400b may send a probe request with the SSID followed by an authentication frame to the AP 400c in Block 621. If the probing client device 400b sends a probe request frame, the method 600 may continue to Block 601. If the probing client device 400b sends an authentication frame the method may optionally end 624 or may continue to Block 606 if the SSID is for a fake network. If the BSSID of the beacon frame or probe response frame is for a real network in Block 622, the method may continue to Block 623 and the AP 400c may direct the probing client device 400b to display a captive portal page and, optionally, the method may end 624.

A skilled artisan will note that one or more of the aspects of the present invention may be performed on a computing device. The skilled artisan will also note that a computing device may be understood to be any device having a processor, memory unit, input, and output. This may include, but is not intended to be limited to, cellular phones, smartphones, tablet computers, laptop computers, desktop computers, personal digital assistants, etc. FIG. 7 illustrates a model computing device in the form of a computer 810, which is capable of performing one or more computer-implemented steps in practicing the method aspects of the present invention. Components of the computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI).

The computer 810 may also include a cryptographic unit 825. Briefly, the cryptographic unit 825 has a calculation function that may be used to verify digital signatures, calculate hashes, digitally sign hash values, and encrypt or decrypt data. The cryptographic unit 825 may also have a protected memory for storing keys and other secret data. In other embodiments, the functions of the cryptographic unit may be instantiated in software and run via the operating system.

A computer 810 typically includes a variety of computer readable media. Computer readable media can be any available media that can be accessed by a computer 810 and includes both volatile and nonvolatile media, removable and non-removable media. By way of example, and not limitation, computer readable media may include computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer 810. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 7 illustrates an operating system (OS) 834, application programs 835, other program modules 836, and program data 837.

The computer 810 may also include other removable/non-removable, volatile/nonvolatile computer storage media. By way of example only, FIG. 7 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives, and their associated computer storage media discussed above and illustrated in FIG. 7, provide storage of computer readable instructions, data structures, program modules and other data for the computer 810. In FIG. 7, for example, hard disk drive 841 is illustrated as storing an OS 844, application programs 845, other program modules 846, and program data 847. Note that these components can either be the same as or different from OS 833, application programs 833, other program modules 836, and program data 837. The OS 844, application programs 845, other program modules 846, and program data 847 are given different numbers here to illustrate that, at a minimum, they may be different copies. A user may enter commands and information into the computer 810 through input devices such as a keyboard 862 and cursor control device 861, commonly referred to as a mouse, trackball or touch pad. Other input devices (not shown) may include a microphone, joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A monitor 891 or other type of display device is also connected to the system bus 821 via an interface, such as a graphics controller 890. In addition to the monitor, computers may also include other peripheral output devices such as speakers 897 and printer 896, which may be connected through an output peripheral interface 895.

The computer 810 may operate in a networked environment using logical connections to one or more remote computers, such as a remote computer 880. The remote computer 880 may be a personal computer, a server, a router, a network PC, a peer device or other common network node, and typically includes many or all of the elements described above relative to the computer 810, although only a memory storage device 881 has been illustrated in FIG. 7. The logical connections depicted in FIG. 7 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 7 illustrates remote application programs 885 as residing on memory device 881.

The communications connections 870 and 872 allow the device to communicate with other devices. The communications connections 870 and 872 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

It will be appreciated that some exemplary embodiments described herein may include unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the two approaches may be used. Moreover, some exemplary embodiments may be implemented as a computer-readable storage medium having computer readable code stored thereon for programming a computer, server, appliance, device, etc. each of which may include a processor to perform methods as described and claimed herein.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products (e.g., one or more modules of computer program instructions encoded on a tangible program carrier for execution by, or to control the operation of, data processing apparatus).

A computer program (also known as a program, software, software application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Additionally, the logic flows and structure block diagrams described in this patent document, which describe particular methods and/or corresponding acts in support of steps and corresponding functions in support of disclosed structural means, may also be utilized to implement corresponding software structures and algorithms, and equivalents thereof. The processes and logic flows described in this specification can be performed by one or more programmable processors executing one or more computer programs to perform functions by operating on input data and generating output.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The computer system may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system performs a portion or all of the processing steps of the invention in response to the processor executing one or more sequences of one or more instructions contained in a memory, such as the main memory. Such instructions may be read into the main memory from another computer readable medium, such as a hard disk or a removable media drive. One or more processors in a multi-processing arrangement may also be employed to execute the sequences of instructions contained in main memory. In alternative embodiments, hard-wired circuitry may be used in place of or in combination with software instructions. Thus, embodiments are not limited to any specific combination of hardware circuitry and software.

The computer code or software code of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

1. A computer-implemented method of mobile campaign provisioning using a dynamic beacon streaming network system comprising a wireless local area network (WLAN) that includes a server and an access point; the method comprising the steps of:
receiving, using a server, at least one of
an access point (AP) identifier of an access point, and
identifying information of a client device, wherein the client device is positioned within wireless communication range of the access point and wherein the identifying information of the client device includes a media access control (MAC) address;
detecting, using the server, that at least one of the MAC address of the client device and the AP identifier of the access point each matches a respective record in a service set identifier (SSID) campaign, defined as a matched SSID campaign;
transmitting, using the server, a dynamic SSID campaign record of the matched SSID campaign to the access point, wherein the dynamic SSID campaign record comprises a first SSID and a display rule associated with the first SSID; and
transmitting, using the access point, the first SSID of the dynamic SSID campaign record by executing the display rule associated with the first SSID; and
displaying, using the client device, the first SSID as a first user-selectable network name.

2. The computer-implemented method according to claim 1 wherein the first SSID is a network SSID, defined as an identifier configured to provision a mobile campaign message and to provide communication access to the WLAN; and wherein the method further comprises connecting, using the access point, the client device to the WLAN upon detection of selection of the first user-selectable network name.

3. The computer-implemented method according to claim 1 wherein the first SSID is a network SSID, defined as an identifier configured to provision a mobile campaign message and to provide communication access to the WLAN; and wherein the method further comprises connecting, using the access point, the client device to one of a hotspot and a captive portal upon detection of selection of the first user-selectable network name.

4. The computer-implemented method according to claim 1 wherein the first SSID is a fake SSID, defined as an identifier configured to provision a mobile campaign message; and wherein the dynamic SSID campaign record further comprises a second SSID and a display rule associated with the second SSID; and wherein the method further comprises the steps of:
ceasing to transmit, using the access point, the fake SSID upon detection of a trigger of the display rule associated with the fake SSID; and
transmitting, using the access point, the second SSID of the dynamic SSID campaign record by executing the display rule associated with the second SSID.

5. The computer-implemented method according to claim 4 wherein the trigger of the display rule associated with the fake SSID is detection of selection of the first user-selectable network name; and wherein the method further comprises displaying, using the client device, the second SSID as a second user-selectable network name.

6. The computer-implemented method according to claim 4 wherein the trigger of the display rule associated with the fake SSID is detection of a timing event; and wherein the method further comprises displaying, using the client device, the second SSID as a second user-selectable network name.

7. The computer-implemented method according to claim 1 wherein the identifying information of the client device further includes at least one of a timestamp and a signal strength and wherein the method further comprises detecting, using the server, that the MAC address of the client device and at least one of the timestamp and the signal strength each matches a respective record in the matched SSID campaign.

8. The computer-implemented method according to claim 1 wherein the method further comprises the steps of:
storing, using the server, connection event information of the client device; and
detecting, using the server, that the MAC address of the client device and the connection event information of the client device each match a respective record in the matched SSID campaign.

9. The computer-implemented method according to claim 1 wherein transmitting the first SSID further comprises transmitting, using the access point, the first SSID contained within one of a beacon frame and a probe response frame.

10. A dynamic beacon streaming network system comprising a wireless local area network (WLAN) that includes a server characterized by a processor and a service set identifier (SSID) campaign lookup database, and an access point characterized by a processor and an access point control software program;
wherein the access point control software of the access point is configured to
receive identifying information of a client device that is positioned within wireless communication range of the access point, wherein the identifying information of the client device includes a media access control (MAC) address, and
transmit to the server the identifying information of the client device and an access point (AP) identifier of the access point;
wherein the SSID campaign lookup database of the server is configured to
detect that at least one of the MAC address of the client device and the AP identifier of the access point each matches a respective record in a service set identifier (SSID) campaign, defined as a matched SSID campaign, and
transmit to the access point a dynamic SSID campaign record of the matched SSID campaign comprising a first SSID and a display rule associated with the first SSID.

11. The system according to claim 10 wherein the access point control software of the access point is further configured to execute the display rule associated with the first SSID of the dynamic SSID campaign record in order to transmit the first SSID to the client device; and wherein the client device is configured to receive and display the first SSID as a first user-selectable network name.

12. The system according to claim 11 wherein first SSID is a network SSID, defined as an identifier configured to provision a mobile campaign message and to provide communication access to the WLAN; and wherein the access point control software of the access point is further configured to connect the client device to the WLAN upon detection of selection of the first user-selectable network name.

13. The system according to claim 11 wherein the first SSID is a network SSID, defined as an identifier configured to provision a mobile campaign message and to provide communication access to the WLAN; and wherein the access point control software of the access point is further configured to connect the client device to one of a hotspot and a captive portal upon detection of selection of the first user-selectable network name.

14. The system according to claim 11 wherein the first SSID is a fake SSID, defined as an identifier configured to provision a mobile campaign message; and wherein the dynamic SSID campaign record further comprises a second SSID and a display rule associated with the second SSID; and wherein the access point control software of the access point is further configured to:
cease to transmit the fake SSID upon detection of a trigger of the display rule associated with the fake SSID, and
transmit the second SSID of the dynamic SSID campaign record by executing the display rule associated with the second SSID; and
wherein the client device is further configured to receive and display the second SSID as a second user-selectable network name.

15. The system according to claim 14 wherein the trigger of the display rule associated with the fake SSID is detection of selection of the first user-selectable network name.

16. The system according to claim 14 wherein the trigger of the display rule associated with the fake SSID is detection of a timing event.

17. The system according to claim 11 wherein the identifying information of the client device further includes at least one of a timestamp and a signal strength; and wherein the SSID campaign lookup database of the server is further configured to detect that the MAC address of the client device and at least one of the timestamp and the signal strength each matches a respective record in the matched SSID campaign.

18. The system according to claim 11 wherein the SSID campaign lookup database of the server is further configured to store connection event information of the client device, and to detect that the MAC address of the client device and the connection event information of the client device each match a respective record in the matched SSID campaign.

19. The method according to claim 11 wherein the access point control software of the access point is further configured to transmit the first SSID contained within one of a beacon frame and a probe response frame.

20. A computer-implemented method of mobile campaign provisioning using a dynamic beacon streaming network system comprising a wireless local area network (WLAN) that includes a server and an access point; the method comprising the steps of:
receiving, using the server, at least one of
an access point (AP) identifier of the access point, and
respective identifying information for each of a plurality of client devices, wherein the plurality of client devices are simultaneously positioned within wireless communication range of the access point and wherein the identifying information of each of the client devices includes a respective media access control (MAC) address;
detecting, using the server, that the MAC address of a first client device of the plurality of client devices and the AP identifier of the access point each matches a respective record in a service set identifier (SSID) campaign, defined as a first matched SSID campaign;
detecting, using the server, that the MAC address of a second client device of the plurality of client devices and the AP identifier of the access point each matches a respective record in the service set identifier (SSID) campaign, defined as a second matched SSID campaign;
transmitting, using the server, a dynamic SSID campaign record of the first matched SSID campaign to the access point, wherein the dynamic SSID campaign record of the first matched SSID campaign comprises a first SSID and a display rule associated with the first SSID;
transmitting, using the server, a dynamic SSID campaign record of the second matched SSID campaign to the access point [400c], wherein the dynamic SSID campaign record of the second matched SSID campaign comprises a second SSID and a display rule associated with the second SSID;
transmitting, using the access point, the first SSID by executing the display rule associated with the first SSID;
transmitting, using the access point, the second SSID by executing the display rule associated with the second SSID;
displaying, using the client device, the first SSID; and
displaying, using the client device, the second SSID.
